(19) United States
(12) Patent Application Publication
(10) Pub. No.: US 2024/0368315 A1
(43) Pub. Date: Nov. 7, 2024

(54) A Process and an Apparatus for Manufacturing Polyethylene

(71) Applicant: Reliance Industries Limited, Maharashtra (IN)

(72) Inventors: Viral Balvantray Desai, Gujarat (IN); Gangaram Moolnarayan, Gujarat (IN); Aniruddha Dattatraya Deshpande, Maharashtra (IN)

(73) Assignee: Reliance Industries Limited, Maharashtra (IN)

(21) Appl. No.: 18/690,386

(22) PCT Filed: Oct. 17, 2022
(86) PCT No.: PCT/IB2022/059923

§ 371 Date: Mar. 8, 2024

(30) Foreign Application Priority Data
Oct. 19, 2021 (IN) 202121047437

(51) Int. Cl. C08F 10/02; B01D 3/14; B01D 15/08; B01J 8/20

(52) U.S. Cl. CPC C08F 10/02; B01D 3/143; B01D 15/08; B01J 8/20

(57) ABSTRACT

The present disclosure relates to a process for manufacturing polyethylene. In the process, the purified liquid medium obtained from the wax-distilling process is further fed to a distillation column to obtain wet hexane comprising hexane fraction and moisture from the top of the column and heavies from the bottom of the column. The so obtained wet hexane is then treated in an adsorption unit to obtain dry hexane, which can be back-fed into the polymerization process. The process yields hexane with reduction in the concentration of the heavies, leading to reduction in the fouling of reactors and other equipments, thereby reducing the downtime of the reactors. The present disclosure also discloses an apparatus for manufacturing polyethylene. The apparatus has a simple and economic design and can be retrofitted in the existing plants.

### FIELD

The present disclosure relates to a field of polymer technology. Particularly, the present disclosure relates to a process and an apparatus for manufacturing polyethylene.

### Definition

As used in the present disclosure, the following terms are generally intended to have the meaning as set forth below, except to the extent that the context in which they are used to indicate otherwise.

High Density Polyethylene (HDPE): High-density polyethylene (HDPE) or polyethylene high-density (PEHD) is a thermoplastic polymer produced from the monomer ethylene. The density of HDPE can range from 930 to 970 kg/m³.

Heavies or Heaviers: In distillation, ‘heavies’ or ‘heaviers’ are the components which comparatively have a higher boiling point than the other components present in the composition to be distilled, and are therefore withdrawn from the bottom of the column. In the invention of the present disclosure, heavies are components heavier than the diluent (hexane) and oligomers, and are often vaporized along with the diluent during the polymerization and separation process. Conventionally, during the recycling of the diluent, a vapor stream containing the diluent and heavies may be condensed and returned to the reactors as a recycle stream of the diluent and heavies.

Impurities: The term ‘impurities’ refer to the heavies such as 2,3 dimethyl-1-hexane, 2,4-dimethylhexane, ethylcyclohexane, 2,4,4-trimethylhexane, 2-methylnonane and undecene. Lighters: The term ‘lighters’ refer to the components having a boiling point comparatively lower than the top operating temperature of the column, and are obtained at the top of the column during the column operation.

Hexane fraction: The term ‘hexane fraction’ refers to a fraction that is obtained during the processing of purified liquid medium in at least one distillation unit and comprises n-hexane, 2-methyl-pentane, 3-methyl pentane, and methyl cyclopentane.

Wet hexane: The term ‘wet hexane’ refers to the hexane fraction having a moisture content in the range of 50 ppm to 100 ppm.

Dry hexane: The term ‘dry hexane’ refers to the hexane fraction having a moisture content of less than 25 ppm.

### BACKGROUND

The background information herein below relates to the present disclosure but is not necessarily prior art.

Polyolefins are prepared by polymerization of olefins in one or more reactors. The feed material for the preparation of the polyolefins comprises diluent, monomer, co-monomer and catalyst, resulting into a polymerization product and a liquid comprising the diluent.

The production of polyolefin such as polyethylene by a slurry process requires a high purity feed. In order to optimize the production cost, feed materials like diluents can be separated and recycled. The liquid diluent is vaporized at various stages of the polymerization process after the slurry is withdrawn from the reactors. During vaporization, various compounds and contaminants may also be vaporized along with the diluent. In order to recycle the diluents, the obtained liquid comprising the diluent conventionally undergoes a purification process.

Further, in the slurry process for manufacturing of polyethylene (PE), in the reactors operated in series, hexane is used as the solvent media (a diluent). The polymerization process is a highly exothermic process and external outer-coolers are provided in addition to the reactor half-pipe limpet coils for cooling the reactors. The reactors have outer-cooler pumps for transferring of slurry to the outer-coolers and also subsequent slurry transfer to the reactor in series.

Hexane as such is not consumed in process but remains along with polymer and waste streams. An efficient slurry polymerization processes typically recycles as much hexane as possible. The recycled hexane obtained from the conventional purification processes contains higher percentages of the heavies. These impurities tend to foul the reactors, outer-coolers and even adsorbents, wherein the problem becomes quite acute; since, in the process, 70-80% of recycled hexane is pumped in to the polymerization unit. This also leads to the fouling of the reactor and outer-coolers. Due to heavy fouling, the heat-mass transfer becomes limiting in the plant, and therefore, the plant is forced to be operated at a lower load.

The conventionally used purification processes in the PE plant is designed to remove lighters (butene) from hexane. The n-hexane content in the procured solvent is about 42-44%, and balance is lighters and heavies. During the conventional purification processes, lighters get separated, and the heavies along with oligomers get accumulated over a period. Some heavies get purged out with wax. The recycled hexane, if comprises higher percentages of the heavies, the frequency of hot boiling of reactors and the other equipments to remove fouling increases, in turn increasing the downtime of the reactors. The drawbacks of such systems can lead to process delays, increased costs, and other inefficiencies. Further, the infrastructure required for producing, maintaining, and recycling hexane as well as the equipment and energy costs associated with the purification of hexane incurs high cost.

There is therefore a need to provide a process and an apparatus for manufacturing polyethylene that mitigates the drawback mentioned hereinabove.

### OBJECTS

Some of the objects of the present disclosure, which at least one embodiment herein satisfies, are as follows.

It is an object of the present disclosure to ameliorate one or more problems of the prior art or to at least provide a useful alternative.

Another object of the present disclosure is to provide a process for manufacturing polyethylene.

Yet another object of the present disclosure is to provide a process for manufacturing polyethylene, which recycles hexane.

Still another object of the present disclosure is to provide a process for manufacturing polyethylene, which recycles hexane having minimum percentage of the heavies.

Yet another object of the present disclosure is to provide a process for manufacturing polyethylene, which recycles hexane having minimum percentages of the heavies and thus reduces fouling of the reactors and other equipments.

Still another object of the present disclosure is to provide an apparatus for manufacturing polyethylene.

Yet another object of the present disclosure is to provide an apparatus for manufacturing polyethylene having optimum heat-mass transfer due to reduced fouling.

Still another object of the present disclosure is to provide an apparatus for manufacturing polyethylene which has minimum downtime.

Yet another object of the present disclosure is to provide an apparatus for manufacturing polyethylene which is user-friendly, economic and can be retrofitted in the existing apparatus.

Other objects and advantages of the present disclosure will be more apparent from the following description, which is not intended to limit the scope of the present disclosure.

### SUMMARY

In accordance with an aspect of the present disclosure, there is provided a slurry process for manufacturing polyethylene. The process comprises polymerizing ethylene monomers, and optionally one or more co-monomers, in hexane in the presence of a catalyst to obtain a slurry containing mixture of polymer in a liquid medium. The polymer is then separated from the liquid medium to obtain separated polymer and separated liquid medium. The separated polymer is then treated to obtain polyethylene. In at least one wax distillation column, the separated liquid medium is treated to obtain a polyethylene wax and a purified liquid medium. The obtained purified liquid medium is then treated in at least one distillation column operating at a temperature in the range of 85° C. to 140° C. and at a pressure in the range of 0.5 kg/cm² to 1 kg/cm², to obtain wet hexane comprising hexane and moisture from the top of the at least one distillation column and the heavies from bottom of the at least one distillation column. The moisture from the wet hexane is adsorbed in an adsorption unit to obtain dry hexane. The obtained dry hexane is then used in the polymerizing process.

In accordance with another aspect of the present disclosure, there is provided an apparatus (1000) for manufacturing polyethylene. The apparatus comprises at least one polymerizing unit (1001), for polymerization of monomers to obtain a slurry containing mixture of polymer in a liquid medium; at least one separating unit (1002) and at least one treating unit (1003) downstream of the polymerizing unit (1001), for receiving the slurry from the polymerizing unit, and separating the polymer from the liquid medium, and treating the separated polymer to obtain polyethylene; at least one wax distillation unit (1005) downstream of the separating unit (1002), comprising at least one wax distillation column, for receiving the separated liquid medium from at least one separating and treating unit, and treating the separated liquid medium to remove polyethylene wax and obtain purified liquid medium comprising hexane, heavies and moisture; at least one distillation column unit (1006) downstream of the wax distillation unit (1005), for receiving a purified liquid medium from the wax distillation unit and treating the purified liquid medium in at least one distillation column, to obtain wet hexane comprising hexane fraction and moisture and remove the heavies; at least one adsorption unit (1007) downstream of the distillation column unit (1006), for receiving the wet hexane from the distillation column unit and separating moisture from the hexane fraction by adsorbing the moisture from the wet hexane to obtain dry hexane; and at least one conduit (1010) downstream of the adsorption unit (1007) in fluid communication with the polymerization unit (1001), for recycling the dry hexane from the at least one adsorption unit and the at least one storage unit to the at least one polymerizing unit (1001).

### BRIEF DESCRIPTION OF ACCOMPANYING DRAWING

A process and an apparatus for manufacturing polyethylene will now be described with the help of the accompanying drawing, in which:

FIG. 1 depicts a block diagram of an apparatus for manufacturing polyethylene in accordance with an embodiment of the present disclosure.

FIG. 2 depicts process flow diagram of wax distillation unit, and distillation column unit in accordance with an embodiment of the present disclosure.

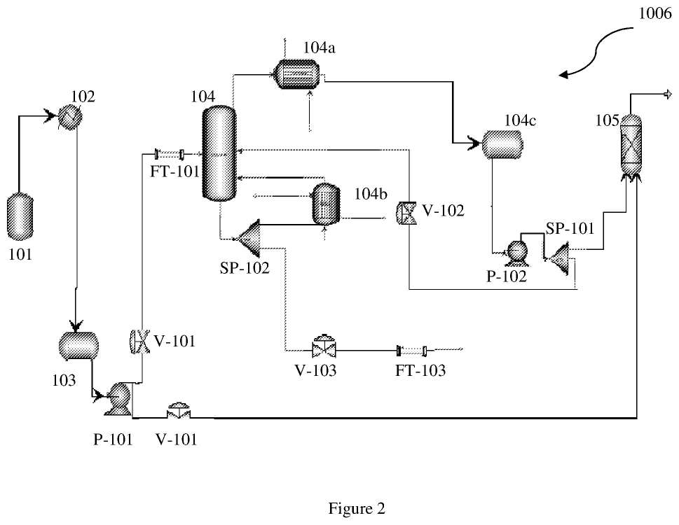

FIG. 3 depicts a flow chart for a process for manufacturing polyethylene in accordance with an embodiment of the present disclosure.

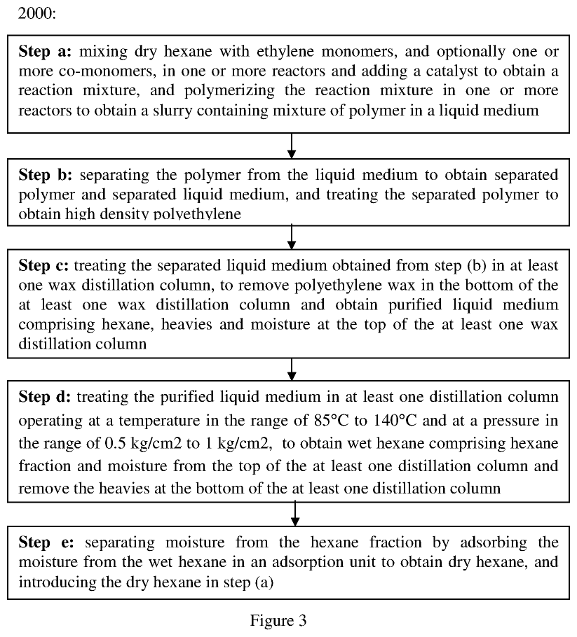

### LIST OF REFERENCE NUMERALS USED IN DETAILED DESCRIPTION AND DRAWING

| Reference | |
|---|---|
| number | Elements |
| 1000 | an apparatus for manufacturing polyethylene |
| 1001 | polymerizing unit |
| 1002 | separating unit |
| 1003 | treating unit |
| 1004 | polyethylene storage |
| 1005 | wax distillation unit |
| 1006 | distillation column unit |
| 1007 | adsorption unit |
| 1008 | first storage unit |
| 1009 | second storage unit |
| 1010 | conduit downstream of the adsorption unit |
| | and the second storage unit in fluid communication |
| | of the polymerization unit |
| 101 | wax distillation column |
| 102 | condenser for condensing purified liquid medium |
| 103 | collection tank for purified liquid medium |
| P-101 | feed pump for purified liquid medium |
| V-101 | flow control valve for purified liquid medium feed |
| FT-101 | flow transmitter for purified liquid medium feed |
| 104 | distillation column |
| 104a | condenser for distillation column |
| 104b | reboiler for distillation column |
| 104c | reflux drum for distillation column |
| P-102 | reflux pump for distillation column |
| V-102 | flow control valve for reflux feed flow |
| 105 | adsorption column |
| V-103 | flow control valve for withdraw of the heavies |
| FT-103 | flow transmitter for withdraw of the heavies |
| 2000 | a process for manufacturing polyethylene |

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

The production of polyolefin such as polyethylene by a slurry process requires a high purity feed. In order to optimize the production cost, feed materials like diluents can be separated and recycled. The liquid diluent is vaporized at various stages of the polymerization process after the slurry is withdrawn from the reactors. During vaporization, various compounds and contaminants are also vaporized along with the diluent.

In the polyethylene manufacturing process, hexane is used as a diluent. During the conventionally used purification processes, lighters get separated, while the heavies along with oligomers generated get accumulate over a period. The recycled hexane (diluent), if comprises higher percentages of the heavies, the frequency of hot boiling of reactors and the other equipments to remove fouling increases, in turn increasing the downtime of the reactors. The drawbacks of such systems can lead to process delays, increased costs, and other inefficiencies.

In an aspect, of the present disclosure, there is provided a slurry process for manufacturing polyethylene. The process is described in detail as follows:

The ethylene monomers, and optionally one or more co-monomers, are polymerized in at least one polymerization reactors, in the presence of a catalyst and dry hexane as a diluent to obtain a slurry comprising mixture of polymer in a liquid medium. Fresh and recycled hexane is fed to the reactors with the catalyst and the co-catalyst.

The polymerization reactions are highly exothermic, and the heat of polymerization is removed via water cooled jackets. Further, external coolers are also provided.

The slurry obtained in one or more polymerizing reactors is then transferred to at least one separating unit and at least one treating unit. In the at least one separating unit, the polymer is separated from the liquid medium to obtain separated polymer and separated liquid medium. In an embodiment, the separation is performed in a decanter centrifuge.

The separated polymer is then treated in at least one treating unit to obtain polyethylene. The treatment comprises drying and post processing the obtained polyethylene. In an embodiment, the drying means is a fixed bed dryer. In the dryer the last remaining hexane is stripped off and then recovered.

The obtained separated liquid medium is then treated in at least one wax distillation column, to remove polyethylene wax in the bottom of the at least one wax distillation column and obtain purified liquid medium comprising hexane, heavies and moisture at the top of the at least one wax distillation column.

In an embodiment, the wax distillation column is operated at a temperature in the range of 69° C. to 82° C. and at a pressure in the range of 0.4 kg/cm² to 0.45 kg/cm². In another embodiment, the temperature at the top of the wax distillation column is in the range of 69° C. to 70° C. and the temperature at the bottom of the wax distillation column is in the range of 82° C. to 83° C. The pressure is in the range of 0.4 kg/cm² to 0.45 kg/cm².

The purified liquid medium obtained from the top of the wax distillation unit is then transferred to at least one distillation column operating at a temperature in the range of 85° C. to 140° C. and at a pressure in the range of 0.5 kg/cm² to 1 kg/cm², to obtain wet hexane comprising hexane fraction and moisture from the top of the at least one distillation column and remove the heavies at bottom of the at least one distillation column. The wet hexane is then condensed.

The obtained wet hexane is then treated in at least one adsorption unit for separating moisture from the hexane fraction by adsorbing the moisture from the wet hexane to obtain dry hexane. The dry hexane is then introduced in the polymerizing process. Dry hexane is must while introducing the hexane in the polymerizing process, since moisture in hexane may deactivate the catalyst active site.

In an embodiment of the present disclosure, a first portion of the wet hexane is recirculated back to the at least one distillation column as a reflux and a second portion of the wet hexane is fed to an adsorption unit. In an embodiment of the present disclosure, the reflux ratio is in the range of 0.5 to 0.8. The reflux ratio is the ratio of the liquid returned to the column divided by the liquid removed as product from the same column.

In an embodiment of the present disclosure, the heavies in the wet hexane are in an amount in the range of 0.1% to 0.2%.

In an embodiment of the present disclosure, the moisture content in the wet hexane is in the range of 50 ppm to 100 ppm.

In an embodiment of the present disclosure, the hexane fraction has a purity in the range of 99.5% to 99.9%.

In an embodiment of the present disclosure, the purified liquid medium comprises lighters in an amount in the range of 0.01 to 2 weight %, n-hexane in an amount in the range of 40 to 65 weight %, 2-methyl-pentane in an amount in the range of 5 to 20 weight %, 3-methyl pentane in an amount in the range of 10 to 30 weight %, methyl cyclopentane in an amount in the range of 10 to 20 weight %, heavies in an amount in the range of 0.1 to 12 weight % and moisture in an amount in the range of 50 to 100 ppm. In an exemplary embodiment, the purified liquid medium comprises n-hexane in an amount of 42.87 weight %, 2-methyl-pentane in an amount of 19.189 weight %, 3-methyl pentane in an amount of 14.821 weight %, methyl cyclopentane in an amount of 10.91 weight %, heavies in an amount of 7.49 weight %, and moisture in an amount of 60 ppm.

In an embodiment of the present disclosure, the heavies comprises 2,3-Dimethyl-1-hexene in an amount in the range of 0.01 to 2 weight %, 2,4-dimethylhexane in an amount in the range of 0.001 to 10 weight %, ethylcyclohexane in an amount in the range of 0.001 to 2 weight %, 2,4,4-trimethylhexane in an amount in the range of 0.001 to 2 weight %, 2-methylnonane in an amount in the range of 0.01 to 3 weight %, 1-undecene in an amount in the range of 0.001 to 2 weight %.

In an embodiment of the present disclosure, the lighters comprises 2,2-dimethyl-butane.

In another embodiment of the present disclosure, the purified liquid medium comprises lighters in an amount in the range of 0.01 to 5 weight %, n-hexane in an amount in the range of 40 to 65 weight %, 2-methyl-pentane in an amount in the range of 5 to 20 weight %, 3-methyl pentane in an amount in the range of 10 to 30 weight %, methyl cyclopentane in an amount in the range of 10 to 20 weight %; and heavies in an amount in the range of 0.1 to 2 weight % and moisture in an amount in the range of 50 to 100 ppm. In another exemplary embodiment, the purified liquid medium comprises n-hexane in an amount of 60.06 weight %, 2-methyl-pentane in an amount of 10.99 weight %, 3-methyl pentane in an amount of 14.8 weight %, methyl cyclopentane in an amount of 12.97 weight %, lighters in an amount of 0.53%; and heavies in an amount of 0.52 weight %.

In an embodiment of the present disclosure, the hexane fraction comprises n-hexane in an amount in the range of 55 to 65 weight %; 2-methyl-pentane in an amount in the range of 5 to 25 weight %; 3-methyl pentane in an amount in the range of 10 to 20 weight %; methyl cyclopentane in an amount in the range of 10 to 20 weight % and moisture in an amount in the range of 50 to 100 ppm. In an exemplary embodiment, the hexane fraction comprises n-hexane in an amount of 46.146 weight %, 2-methyl-pentane in an amount of 20.719 weight %, 3-methyl pentane in an amount of 15.989 weight %, methyl cyclopentane in an amount of 11.719 weight %.

In an embodiment of the present disclosure, the heavies obtained at the bottom of the at least one distillation column have a temperature in the range of 130° C. to 140° C.

In an embodiment of the present disclosure, the wet hexane obtained at the top of the distillation column has a temperature in the range of 85° C. to 90° C..

In an embodiment of the present disclosure, the amount of hexane in the heavies is in the range of 0.001% to 2%.

In an embodiment of the present disclosure, the treating of the polymers comprises drying the polymers, post-processing to obtain a polyethylene.

The wet hexane obtained from at least one distillation column can be tapped out for use in a process that needs wet hexane. The obtained wet hexane is stored in at least one first storage unit. Further, the dry hexane is stored in at least one second storage units for further use and for introducing in the polymerization step.

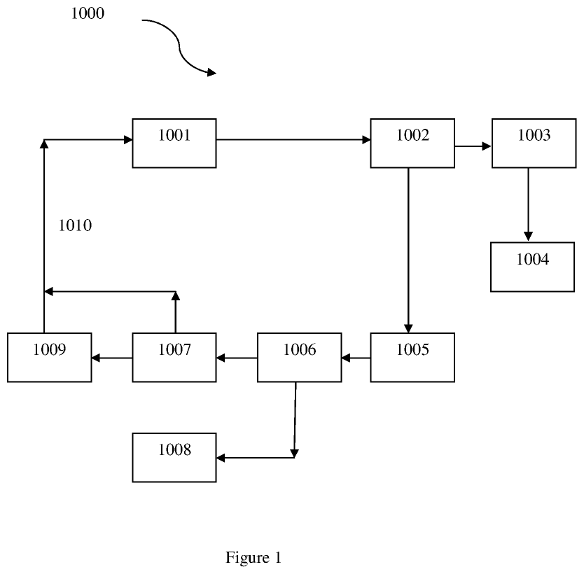

In another aspect, the present disclosure provides an apparatus for manufacturing polyethylene. An apparatus (1000), of the present disclosure, will now be described with reference to FIG. 1. The preferred embodiment does not limit the scope and ambit of the present disclosure.

The apparatus (1000) comprises at least one polymerizing unit (1001), for polymerization of monomers to obtain a slurry containing mixture of polymer in a liquid medium. In the downstream of polymerizing unit (1001), there is at least one separating unit (1002) and at least one treating unit (1003), for receiving the slurry from the polymerizing unit, and separating the polymer from the liquid medium, and treating the separated polymer to obtain polyethylene.

There is at least one wax distillation unit (1005) downstream of the separating unit (1002), comprising at least one wax distillation column, for receiving the separated liquid medium from at least one separating and treating unit, and treating the separated liquid medium to remove polyethylene wax and obtain purified liquid medium comprising hexane, heavies and moisture.

In the downstream of wax distillation unit (1005), there is at least one distillation column unit (1006), for receiving purified liquid medium from the wax distillation unit and treating the purified liquid medium in at least one distillation column, to obtain wet hexane comprising hexane fraction and moisture and remove the heavies. In the downstream of at least one distillation column unit (1006), there is at least one adsorption unit (1007), for receiving the wet hexane from the distillation column unit and separating moisture from the hexane fraction by adsorbing the moisture from the wet hexane to obtain dry hexane.

In the downstream of at least one adsorption unit (1007), there is at least one conduit (1010) in fluid communication with the polymerization unit (1001), for recycling the dry hexane from the at least one adsorption unit and the at least one storage unit to the at least one polymerizing unit (1001).

In an embodiment, the apparatus comprises at least one first storage unit (1008) downstream of the at least one distillation column unit (1006), for storage of wet hexane.

In accordance with another embodiment, the apparatus comprises at least one second storage unit (1009) downstream of the adsorption unit (1007), for storage of dry hexane.

In the system, at least one distillation column unit (1006) comprises at least one distillation column (104), comprising at least one first inlet adapted to receive the stream of purified liquid medium from the wax distillation unit (1005), at least one outlet in the upper section of the distillation column (104), adapted to obtain wet hexane comprising hexane fraction and moisture and at least one outlet in the bottom section of the distillation column (104) adapted to obtain heavies, and at least one inserts inside the distillation column (104) selected from trays and packing, and at least one second inlet, adapted to feed the wet hexane to the top section of the distillation column. The unit comprises at least one condenser (104a), in fluid communication with the at least one outlet in the upper section of the distillation column, adapted to obtain the wet hexane and condense the wet hexane and at least one reboiler (104b), in fluid communication with the at least one outlet in the bottom section of the distillation column, adapted to obtain heavies and reheat the heavies.

The distillation unit further comprises at least one first flow control valve (V-101), upstream of the distillation column, adapted to control a flow of the stream of purified liquid medium to the distillation column (104), at least one second flow control valve (V-102), upstream of the distillation column, adapted to control a flow of wet hexane to the distillation column, at least one flow control valve (V-103), downstream of the reboiler, adapted to control a flow of the heavies from the reboiler.

The system in accordance with the present disclosure has a simple and economic design, is user friendly and can be retrofitted in the existing plants.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further illustrated herein below with the help of the following experiments. The experiments used herein are intended merely to facilitate an understanding of the ways in which the embodiments herein may be practiced and to further enable those of skilled in the art to practice the embodiments herein. Accordingly, the experiments should not be construed as limiting the scope and scale of the embodiments herein.

### Experiment 1: Manufacturing of Polyethylene in Accordance with the Prior Art

In a polymerization reactor, with 20000 kg/hr feed, polymerization was performed in the presence of catalyst and dry hexane as a diluent to obtain a slurry containing mixture of polymer in a liquid medium. The polymerized slurry was then decanted to obtain separated polymer and separated liquid medium. The separated polymer product was then transferred to a dryer to obtain dried polyethylene. The separated liquid medium from the decantation process was fed to a wax distillation column to obtain purified liquid medium from the top of the column and polyethylene wax from the bottom of the column was removed. The obtained purified liquid medium was then fed to an absorption column to obtain dry hexane.

### Results and Discussion:

The composition of the purified liquid medium obtained from the wax distillation column is provided in Table 1.

TABLE 1
The composition of the purified liquid medium
obtained from the wax distillation column

| | Weight % at the top of the | Weight % |
|---|---|---|
| Components | wax distillation column | (Heavies) |
| 2,2-Dimethyl Butane | 0.130 | — |
| 2-Methyl-Pentane | 19.198 | — |
| 3-Methyl-Pentane | 14.821 | — |
| N-Hexane | 42.870 | — |
| Cyclohexane | 4.519 | — |
| Methylcyclopentane | 10.910 | — |
| Cis-3-Hexene | 0.012 | — |
| 2,3-Dimethyl-1-Hexene | 0.153745 | 0.153745 |
| 2,4-Dimethylhexane | 6.782008 | 6.782008 |
| Ethylcyclohexane | 0.04228 | 0.04228 |
| 2,4,4-Trimethylhexane | 0.0366609 | 0.036609 |
| 2-Methylnonane | 0.4711115 | 0.4711115 |
| 1-Undecene | 0.049326 | 0.049326 |

It is evident from the table that the purified liquid medium obtained from the wax distillation column has 7.53% impurities (heavies). It was observed that when this purified liquid medium was treated in an adsorption unit and recycled. It was observed that the due the higher percentage of heavies in the recycled hexane fouled the reactors, outer-coolers, and even adsorbents. Further, due to heavy fouling, the heat-mass transfer became a limiting in the plant, and therefore, the plant was forced to be operated at a lower load leading to heavy economic losses. Hence, due to heavies accumulation in hexane there is tendency of intercooler fouling and which can create economic impact of slow down or shutdown.

### Experiment 2: Manufacturing of Polyethylene in Accordance with the Present Disclosure

In a polymerization reactor, with 20000 kg/hr feed, polymerization was performed in the presence of catalyst and dry hexane as a diluent to obtain a slurry containing mixture of polymer in a liquid medium. The polymerized slurry was then decanted to obtain separated polymer and separated liquid medium. The separated polymer product was then transferred to a dryer to obtain dried polyethylene. The separated liquid medium from the decantation process was fed to a wax distillation column to obtain purified liquid medium from the top of the column and polyethylene wax from the bottom of the column was removed. The composition of the purified liquid medium obtained from the wax distillation column is provided in Table 2.

TABLE 2
The composition of the purified liquid medium
obtained from the wax distillation column

| | Weight % at the top of the | Weight % |
|---|---|---|
| Components | wax distillation column | (Heavies) |
| 2,2-Dimethyl Butane | 0.130 | — |
| 2-Methyl-Pentane | 19.198 | — |
| 3-Methyl-Pentane | 14.821 | — |
| N-Hexane | 42.870 | — |
| Cyclohexane | 4.519 | — |
| Methylcyclopentane | 10.910 | — |
| Cis-3-Hexene | 0.012 | — |
| 2,3-Dimethyl-1-Hexene | 0.153745 | 0.153745 |
| 2,4-Dimethylhexane | 6.782008 | 6.782008 |
| Ethylcyclohexane | 0.04228 | 0.04228 |
| 2,4,4-Trimethylhexane | 0.036609 | 0.036609 |
| 2-Methylnonane | 0.4711115 | 0.4711115 |
| 1-Undecene | 0.049326 | 0.049326 |

The obtained purified liquid medium was then fed to a distillation column to obtain wet hexane comprising a hexane fraction and moisture. The hexane fraction comprised n-hexane, 2-methyl-pentane, and methyl cyclopentane.

Design Basis: The column was designed for 4000 Kg/hr feed to handle existing heavies composition. The column diameter was 1 meter for packed tower and 0.8 meter for sieve trays. The column was operated at a pressure of 0.5 Kg/cm². The temperature at the top of the column was maintained at 80° C., and the temperature at the bottom of the column was maintained at 147° C.

The composition of the hexane fraction obtained at the top and the heavies obtained at the bottom of the distillation column is provided in Table 3.

TABLE 3
The composition of the hexane fraction obtained
at the top of the distillation column and the heavies
at the bottom of the distillation column:

| | Weight % of the | Weight % of the |
|---|---|---|
| | hexane fraction | heavies obtained |
| | obtained at the | at the bottom |
| Components | top of the column | of the column |
| 2,2-Dimethyl Butane | 0.140 | 0.000 |
| 2-Methyl-Pentane | 20.719 | 0.067 |
| 3-Methyl-Pentane | 15.989 | 0.124 |
| N-Hexane | 46.449 | 1.605 |
| Cyclohexane | 4.626 | 3.175 |
| Methylcyclopentane | 11.719 | 0.733 |
| Cis-3-Hexene | 0.013 | 0.000 |
| 2,3-Dimethyl-1-Hexene | 0.013 | 1.924 |
| 2,4-Dimethylhexane | 0.328 | 84.261 |
| Ethylcyclohexane | 0.001 | 0.563 |
| 2,4,4-Trimethylhexane | 0.001 | 0.488 |
| 2-Methylnonane | 0.001 | 6.389 |
| 1-Undecene | 0.000 | 0.670 |

It is evident from table 3 that the entire hexane fraction present in the feed is withdrawn from the top of the column, and the heavies are removed from the bottom of the distillation column. Thus, the impurities are largely reduced in the top product, and the top product has 0.344% impurities. Thus, due to the reduction in the impurities in the present invention as compared to the prior art, the fouling of the reactors and the other equipments is reduced, in turn reducing the downtime of the reactors.

Further, the flowrate considered is on higher side, and once the heavies are purged out the actual feed requirement will be much smaller.

### Experiment 3-6: Manufacturing of Polyethylene in Accordance with the Present Disclosure

Experiment 2 was repeated with different feed compositions, following all the process steps as performed in experiment 2.

Experiment 3: The feed and the top product compositions for Experiment 3 are provided in Table 4:

TABLE 4
The feed and the top product composition
in accordance with Experiment 3:

| | Weight % of the | Weight % |
|---|---|---|
| | purified liquid | top product |
| | medium (feed to the | (hexane |
| Components | distillation column) | fraction) |
| 2-Methyl pentane | 10.99 | 11.06 |
| 3-Methyl Pentane | 14.8 | 14.96 |
| n-Hexane | 60.06 | 60.6 |
| Methyl Cyclopentane | 12.97 | 12.72 |
| Cyclohexane | 0.09 | 0.08 |
| Lighters | 0.57 | 0.53 |
| Heaviers | 0.52 | 0.05 |

It is evident from table 4 that the heavies in the feed were 0.52%, whereas the heavies obtained in the top product were only 0.05%. Thus, only the hexane fraction without the impurities was withdrawn from the top of the column, and the heavies were removed from the bottom of the distillation column.

### Experiment 4

The feed and the top product compositions for Experiment 4 are provided in Table 5:

TABLE 5
The feed and the top product composition
in accordance with Experiment 4:

| | Weight % of the | Weight % |
|---|---|---|
| | purified liquid | top product |
| | medium (feed to the | (hexane |
| Components | distillation column) | fraction) |
| 2-Methyl pentane | 7.76 | 7.9 |
| 3-Methyl Pentane | 18.32 | 18.66 |
| n-Hexane | 55.71 | 56.18 |
| Methyl Cyclopentane | 15.98 | 15.4 |
| Cyclohexane | 0.07 | 0.03 |
| Lighters | 1.85 | 1.18 |
| Heaviers | 0.31 | 0.00 |

It is evident from table 5, that the heavies in the feed were 0.31%, whereas there were no heavies present in the top product. Thus, only the hexane fraction without the impurities was withdrawn from the top of the column, and the heavies were removed from the bottom.

### Experiment 5

The feed and the top product compositions for Experiment 5 are provided in Table 6:

TABLE 6
The feed and the top product composition
in accordance with Experiment 5:

| | Weight % of the | Weight % |
|---|---|---|
| | purified liquid | top product |
| | medium (feed to the | (hexane |
| Components | distillation column) | fraction) |
| 2-Methyl pentane | 7.78 | 7.28 |
| 3-Methyl Pentane | 17.81 | 17.26 |
| n-Hexane | 56.9 | 57.84 |
| Methyl Cyclopentane | 15.63 | 16.23 |
| Cyclohexane | 0.03 | 0.03 |
| Lighters | 1.35 | 1.36 |
| Heaviers | 0.52 | 0.01 |

It is evident from table 6 that the heavies in the feed were 0.52%, whereas the heavies obtained in the top product were only 0.01%. Thus, only the hexane fraction present in the feed was withdrawn from the top of the column, and the heavies were removed from the bottom of the distillation column.

### Experiment 6

The feed and the top product compositions for Experiment 6 are provided in Table 7:

TABLE 7
The feed and the top product composition
in accordance with Experiment 6:

| | Weight % of the | Weight % |
|---|---|---|
| | purified liquid | top product |
| | medium (feed to the | (hexane |
| Components | distillation column) | fraction) |
| 2-Methyl pentane | 8.35 | 8.28 |
| 3-Methyl Pentane | 18.8 | 18.6 |
| n-Hexane | 55.12 | 55.34 |
| Methyl Cyclopentane | 14.85 | 15.06 |
| Cyclohexane | 0.04 | 0.03 |
| Lighters | 2.3 | 2.69 |
| Heaviers | 0.54 | 0.00 |

It is evident from table 7, that the heavies in the feed were 0.54%, whereas there were no heavies present in the top product. Thus, only the hexane fraction without the impurities was withdrawn from the top of the column, and the heavies were removed from the bottom of the distillation column.

### Experiment 7

Experiments 2 to 6 were carried out for obtaining high density polyethylene in accordance with the present disclosure, and similar results were obtained.

Thus, in the present invention, due to the reduction in the impurities in the hexane fraction, as compared to the prior art, the fouling of the reactors and the other equipments is reduced, in turn reducing the downtime of the reactors.

### TECHNICAL ADVANCES AND ECONOMICAL SIGNIFICANCE

The present disclosure described herein above has several technical advantages including, but not limited to, the realization of:
a process for manufacturing polyethylene:
   reduction in the concentration of the heavies in the wet hexane;
   reduction in the fouling of reactors and other equipments; and
   reduction in the downtime of reactors.
An apparatus for manufacturing polyethylene:
   can be retrofitted in the existing plants;
   has simple and economic design; and
   optimum heat and mass transfer due to reduced fouling.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A slurry process for manufacturing polyethylene, said process comprising the following steps:
a. mixing dry hexane with ethylene monomers, and optionally one or more co-monomers, in one or more reactors and adding a catalyst to obtain a reaction mixture, and polymerizing said reaction mixture in one or more reactors to obtain a slurry containing mixture of polymer in a liquid medium;
b. separating said polymer from said liquid medium to obtain separated polymer and separated liquid medium, and treating said separated polymer to obtain polyethylene;
c. treating said separated liquid medium obtained from step (b) in at least one wax distillation column, to remove polyethylene wax in the bottom of said at least one wax distillation column and obtain purified liquid medium comprising hexane, heavies and moisture at the top of said at least one wax distillation column;
d. treating said purified liquid medium in at least one distillation column operating at a temperature in the range of 85° C. to 140° C. and at a pressure in the range of 0.5 kg/cm² to 1 kg/cm², to obtain wet hexane comprising hexane fraction and moisture from the top of said at least one distillation column and removing said heavies at the bottom of said at least one distillation column;
e. separating moisture from said hexane fraction by adsorbing said moisture from said wet hexane in an adsorption unit to obtain dry hexane, and introducing said dry hexane in step (a).

2. The process as claimed in claim 1, wherein said heavies in said wet hexane are in an amount in the range of 0.0001% to 0.2%.

3. The process as claimed in claim 1, wherein a moisture content in said wet hexane is in the range of 50 ppm to 100 ppm.

4. The process as claimed in claim 1, wherein said hexane fraction has a purity in the range of 99.5% to 99.9%.

5. The process as claimed in claim 1, wherein said purified liquid medium comprises:
n-hexane in an amount in the range of 40 to 65 weight %;
2-methyl-pentane in an amount in the range of 5 to 20 weight %;
3-methyl pentane in an amount in the range of 10 to 30 weight %;
methyl cyclopentane in an amount in the range of 10 to 20 weight %; and
heavies in an amount in the range of 0.1 to 12 weight %.

6. The process as claimed in claim 1, wherein said hexane fraction comprises:
n-hexane in an amount in the range of 55 to 65 weight %;
2-methyl-pentane in an amount in the range of 5 to 25 weight %;
3-methyl pentane in an amount in the range of 10 to 20 weight %;
methyl cyclopentane in an amount in the range of 10 to 20 weight %; and
heavies in an amount in the range of 0.01 to 0.5 weight %.

7. The process as claimed in claim 1, wherein said heavies obtained at the bottom of said at least one distillation column are at a temperature in the range of 130° C. to 140° C.

8. The process as claimed in claim 1, wherein said wet hexane obtained at the top of said distillation column has a temperature in the range of 85° C. to 90° C.

9. The process as claimed in claim 1, wherein the amount of hexane in said heavies obtained from the bottom of said at least one distillation column is in the range of 0.01% to 0.5%.

10. The process as claimed in claim 1, wherein said treating of said separated polymer obtained in step (b) comprises drying said polymer, and post-processing to obtain a polyethylene.

11. The process as claimed in claim 1, wherein said wet hexane is tapped out for use in at least one process that needs wet hexane.

12. The process as claimed in claim 1, wherein said wet hexane is stored in at least one first storage unit.

13. The process as claimed in claim 1, wherein said dry hexane is stored in at least one second storage unit for further use and for introducing in step (a).

14. An apparatus (1000) for manufacturing polyethylene, said apparatus comprises:
at least one polymerizing unit (1001), for polymerization of monomers to obtain a slurry containing mixture of polymer in a liquid medium;
at least one separating unit (1002) and at least one treating unit (1003) downstream of said polymerizing unit (1001), for receiving said slurry from said polymerizing unit, and separating said polymer from said liquid medium, and treating said separated polymer to obtain polyethylene;
at least one wax distillation unit (1005) downstream of said separating unit (1002), comprising at least one wax distillation column, for receiving said separated liquid medium from at least one separating and treating unit, and treating said separated liquid medium to remove polyethylene wax and obtain purified liquid medium comprising hexane, heavies and moisture;
at least one distillation column unit (1006) downstream of said wax distillation unit (1005), for receiving purified liquid medium from said wax distillation unit and treating said purified liquid medium in at least one distillation column, to obtain wet hexane comprising hexane fraction and moisture and remove said heavies;
at least one adsorption unit (1007) downstream of said distillation column unit (1006), for receiving said wet hexane from said distillation column unit and separating moisture from said hexane fraction by adsorbing said moisture from said wet hexane to obtain dry hexane; and
at least one conduit (1010) downstream of said adsorption unit (1007) in fluid communication with said polymerization unit (1001), for recycling said dry hexane from said at least one adsorption unit and said at least one storage unit to said at least one polymerizing unit (1001).

15. The apparatus as claimed in claim 14, comprises at least one first storage unit (1008) downstream of said at least one distillation column unit (1006), for storage of wet hexane.

16. The apparatus as claimed in claim 14, comprises at least one second storage unit (1009) downstream of said adsorption unit (1007), for storage of dry hexane.

17. The apparatus as claimed in claim 14, wherein said at least one distillation column unit (1006) comprises:
a. at least one distillation column (104) comprising:
i. at least one first inlet adapted to receive said stream of purified liquid medium from said wax distillation unit;
ii. at least one outlet in the upper section of said distillation column, adapted to obtain wet hexane comprising hexane fraction and moisture and;
iii. at least one outlet in the bottom section of said distillation column adapted to obtain heavies;
iv. at least one inserts inside said distillation column selected from trays and packing;
v. at least one second inlet, adapted to feed said wet hexane to the top section of said distillation column;
vi. at least one condenser (104a);
vii. at least one reboiler (104b); and
viii. at least one reflux drum (104c),
such that at least one outlet in the upper portion of said distillation column (104) is in fluid communication with said at least one condenser (104a); and at least outlet in the bottom section of said distillation column (104) is in fluid communication with said at least one reboiler (104b).
b. at least one flow control valve (V-101), upstream of said distillation column, adapted to control a flow to said distillation column unit;
c. at least one flow control valve (V-103), downstream of said reboiler, adapted to control a flow from said reboiler; and
d. at least one flow control valve (v-102), downstream of said reflux drum, adapted to control the feed from said reflux drum to said distillation column.
